(19) United States
(12) Patent Application Publication
(10) Pub. No.: US 2024/0377358 A1
(43) Pub. Date: Nov. 14, 2024

(54) FLOW CELL FOR ELECTROPHORETIC MOBILITY MEASUREMENT

(71) Applicant: Wyatt Technology, LLC, Goleta, CA (US)

(72) Inventors: Shivakumar K. Ramini, Newbury Park, CA (US); Steven P. Trainoff, Santa Barbara, CA (US); Drew Amaral, Goleta, CA (US); Shiladitya Sen, Goleta, CA (US); Grzegora M. Domochowski, Goleta, CA (US)

(21) Appl. No.: 18/661,137

(22) Filed: May 10, 2024

Related U.S. Application Data
(60) Provisional application No. 63/466,243, filed on May 12, 2023.

(51) Int. Cl. G01N 27/447

(52) U.S. Cl. CPC G01N 27/44769; G01N 27/44704

(57) ABSTRACT

A flow cell comprises a top structure including a first set of luer fittings, channels coupled to the first set of luer fittings, where the channels include flow-through cylindrical electrodes, electrical connectors connected to the electrodes to connect to at least one external circuit, and a second set of luer fitting to attach to the channels and to external fluid connectors, and a bottom structure including a set of luer fitting receptacles to connect to the first set of luer fittings, optical windows to transmit in light from a light source and to transmit out scattered light from a sample for detection and analysis, and indexing surfaces to index on an external electrophoretic mobility measurement instrument.

### RELATED APPLICATIONS

This application claims the benefit of and priority to U.S. provisional application No. 63/466,243, filed on May 12, 2023, titled “Flow Cell for Electrophoretic Mobility Measurement,” the entirety of which is incorporated by reference herein.

### BACKGROUND

The present disclosure relates to electrophoretic mobility, and more specifically, to a flow cell for electrophoretic mobility measurement.

The problem with conventional disposable flow cells available in the market is that they cannot deliver all three desired attributes simultaneously. They either use expensive materials for electrodes and optical surfaces to deliver high performance, thus making them expensive, or they use low-cost materials to make the flow cell inexpensive but have a testing time of the order of a few minutes. For example, some flow cells use platinum electrodes and polished pure glass windows. However, they are difficult to clean and use due to trapped bubbles and potential sample carry over. Hence it is not very easy to use and expensive to purchase. Although they are reusable, the amoratized cost per test is low. Also, the electrodes of these flow cells corrode quickly. The Anton paar flow cell is also easy to use, consumable and inexpensive, but its electrodes also corrode quickly and cannot run experiments for long periods of time, such as a day or more.

### SUMMARY

The present disclosure describes a disposable flow cell for electrophoretic mobility measurement that has a low cost per experiment, is easy to use, and can efficiently provide for testing. In an exemplary embodiment, the flow cell includes (1) a top structure including (a) a first set of luer fittings, (b) channels coupled to the first set of luer fittings, where the channels include flow-through cylindrical electrodes, (c) electrical connectors connected to the electrodes to connect to at least one external circuit, and (d) a second set of luer fitting to attach to the channels and to external fluid connectors, and (2) a bottom structure including (a) a set of luer fitting receptacles to connect to the first set of luer fittings, (b) optical windows to transmit in light from a light source and to transmit out scattered light from a sample for detection and analysis, and (c) indexing surfaces to index on an external electrophoretic mobility measurement instrument.

In another aspect, a flow cell comprises a first set of luer fittings, channels coupled to the first set of luer fittings, wherein the channels comprise flow-through cylindrical electrodes, electrical connectors connected to the electrodes to connect to at least one external circuit, and a second set of luer fitting to attach to the channels and to external fluid connectors.

In another aspect, a flow cell comprises a set of luer fitting receptacles to connect to a first set of luer fittings; optical windows; and indexing surfaces to index on an external electrophoretic mobility measurement instrument.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a perspective view of a flow cell for electrophoretic mobility measurements, in accordance with some embodiments.

FIG. 2A is a perspective view of a top structure of the flow cell of FIG. 1

FIG. 2B is a perspective view of electrical connectors of the flow cell of FIGS. 1 and 2A.

FIGS. 3A-3E are several views of a bottom structure of the flow cell of FIG. 1.

FIG. 4 is a graph illustrating a power spectrum output of an electrophoretic measurement instrument that uses the flow cell of FIGS. 1-3E.

### DETAILED DESCRIPTION

The present disclosure describes a flow cell for electrophoretic mobility measurement. In an exemplary embodiment, the flow cell includes (1) a top structure including (a) a first set of luer fittings, (b) channels coupled to the first set of luer fittings, where the channels include flow-through cylindrical electrodes, (c) electrical connectors connected to the electrodes to connect to at least one external circuit, and (d) a second set of luer fitting to attach to the channels and to external fluid connectors, and (2) a bottom structure including (a) a set of luer fitting receptacles to connect to the first set of luer fittings, (b) optical windows to transmit in light from a light source and to transmit out scattered light from a sample for detection and analysis, and (c) indexing surfaces to index on an external electrophoretic mobility measurement instrument. In an embodiment, the top structure does not require optical molding. In an embodiment, the luer fittings are luer locks. In an embodiment, the flow-through cylindrical electrodes allow fluid to flow through them, thereby avoiding the formation of bubbles in the fluid. In an embodiment, the electrical connectors are Be, Cu, or Au plated Cu—Be alloy. In an embodiment, the bottom structure is a pure optical molding.

In an embodiment, the outside surface of each of the optical windows among the optical window is of a good optical quality, where the outside surface would be in contact with air. In an embodiment, the inside surface of each of the optical windows among the optical window is not necessarily of a good optical quality, where the inside surface would be in contact with the sample. In an embodiment, the indexing surfaces are flat surfaces that are positioned 90 degrees to each other.

### Definitions

### Particle

A particle may be a constituent of a liquid sample aliquot. Such particles may be molecules of varying types and sizes, nanoparticles, virus like particles, liposomes, emulsions, bacteria, and colloids. These particles may range in size on the order of nanometer to microns.

### Analysis of Macromolecular or Particle Species in Solution

The analysis of macromolecular or particle species in solution may be achieved by preparing a sample in an appropriate solvent and then injecting an aliquot thereof into a separation system such as a liquid chromatography (LC) column or field flow fractionation (FFF) channel where the different species of particles contained within the sample are separated into their various constituencies. Once separated, generally based on size, mass, or column affinity, the samples may be subjected to analysis by means of light scattering, refractive index, ultraviolet absorption, electrophoretic mobility, and viscometric response.

### Light Scattering

Light scattering (LS) is a non-invasive technique for characterizing macromolecules and a wide range of particles in solution. The two types of light scattering detection frequently used for the characterization of macromolecules are static light scattering and dynamic light scattering.

### Dynamic Light Scattering

Dynamic light scattering is also known as quasi-elastic light scattering (QELS) and photon correlation spectroscopy (PCS). In a DLS experiment, time-dependent fluctuations in the scattered light signal are measured using a fast photodetector. DLS measurements determine the diffusion coefficient of the molecules or particles, which can in turn be used to calculate their hydrodynamic radius.

### Static Light Scattering

Static light scattering (SLS) includes a variety of techniques, such as single angle light scattering (SALS), dual angle light scattering (DALS), low angle light scattering (LALS), and multi-angle light scattering (MALS). SLS experiments generally involve the measurement of the absolute intensity of the light scattered from a sample in solution that is illuminated by a fine beam of light. Such measurement is often used, for appropriate classes of particles/molecules, to determine the size and structure of the sample molecules or particles, and, when combined with knowledge of the sample concentration, the determination of weight average molar mass. In addition, nonlinearity of the intensity of scattered light as a function of sample concentration may be used to measure interparticle interactions and associations.

### Multi-Angle Light Scattering

Multi-angle light scattering (MALS) is a SLS technique for measuring the light scattered by a sample into a plurality of angles. It is used for determining both the absolute molar mass and the average size of molecules in solution, by detecting how they scatter light. Collimated light from a laser source is most often used, in which case the technique can be referred to as multiangle laser light scattering (MALLS). The “multi-angle” term refers to the detection of scattered light at different discrete angles as measured, for example, by a single detector moved over a range that includes the particular angles selected or an array of detectors fixed at specific angular locations.

A MALS measurement requires a set of ancillary elements. Most important among them is a collimated or focused light beam (usually from a laser source producing a collimated beam of monochromatic light) that illuminates a region of the sample. The beam is generally plane-polarized perpendicular to the plane of measurement, though other polarizations may be used especially when studying anisotropic particles. Another required element is an optical cell to hold the sample being measured. Alternatively, cells incorporating means to permit measurement of flowing samples may be employed. If single-particles scattering properties are to be measured, a means to introduce such particles one-at-a-time through the light beam at a point generally equidistant from the surrounding detectors must be provided.

Although most MALS-based measurements are performed in a plane containing a set of detectors usually equidistantly placed from a centrally located sample through which the illuminating beam passes, three-dimensional versions also have been developed where the detectors lie on the surface of a sphere with the sample controlled to pass through its center where it intersects the path of the incident light beam passing along a diameter of the sphere. The MALS technique generally collects multiplexed data sequentially from the outputs of a set of discrete detectors. The MALS light scattering photometer generally has a plurality of detectors.

Normalizing the signals captured by the photodetectors of a MALS detector at each angle may be necessary because different detectors in the MALS detector (i) may have slightly different quantum efficiencies and different gains, and (ii) may look at different geometrical scattering volumes. Without normalizing for these differences, the MALS detector results could be nonsensical and improperly weighted toward different detector angles.

### Electrophoretic Light Scattering

Electrophoretic light scattering (ELS) is a technique used to measure the electrophoretic mobility of particles in dispersion, or molecules in solution. This mobility is often converted to Zeta potential to enable comparison of materials under different experimental conditions. The fundamental physical principle is that of electrophoresis. A dispersion is introduced into a cell containing two electrodes. An electrical field is applied to the electrodes, and particles or molecules that have a net charge, or more strictly a net zeta potential will migrate towards the oppositely charged electrode with a velocity, known as the mobility, that is related to their zeta potential.

When an electric field is applied to a sample, any charged objects in the sample will be influenced by that field. The extra movement that particles exhibit as a result of them experiencing the electric field is called the electrophoretic mobility. Its typical units are μm·cm/V·s (micrometer centimeter per Volt second) since it is a velocity [μm/s] per field strength [V/cm]. The electrophoretic mobility is the direct measurement from which the zeta potential can be derived (using either the Smoluchowski/Debye-Hückel approximations or the complete Henry function F(κa) to get from the mobility to a zeta potential).

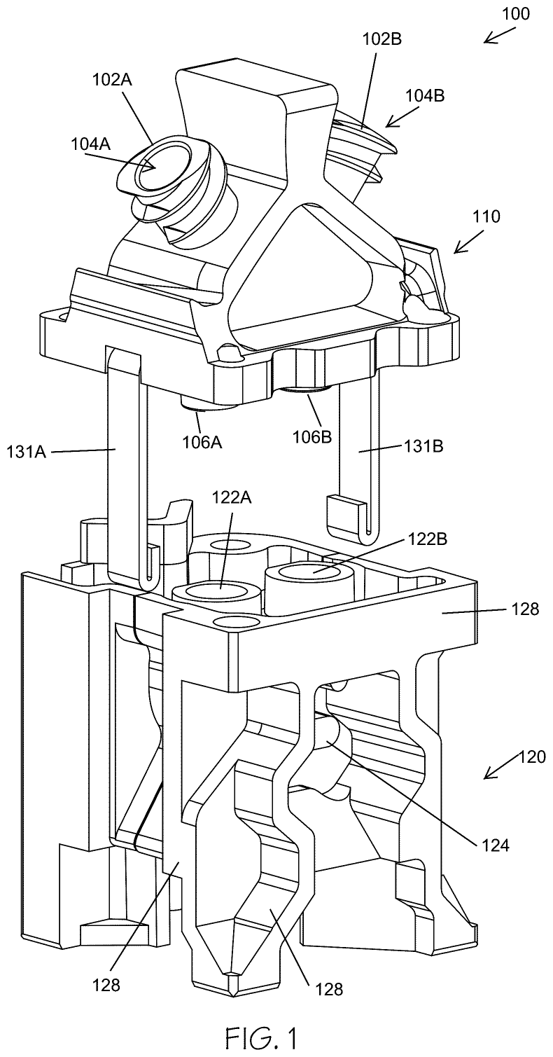

In an embodiment, FIG. 1 depicts an apparatus 100, more specifically, a flow cell, for providing electrophoretic mobility including a top structure 110 including a first set of luer fittings 102, a first channel 104A and a second channel 104B (generally, 104) coupled to the first set of luer fittings 102. The electrophoretic apparatus 100 may be implemented as a flow cell that is compatible with a light scattering measurement system, such as the Wyatt Zetastar system, which can perform different types of measurements, including but not limited to electrophoretic mobility measurements. The construction may include an optical-only cell with inline male and female electrode connectors.

The luer fittings 102 are constructed and arranged to provide inputs, and can engage, or mate, with a sample injection apparatus or system, such as a syringe, pipette, auto-injector, and so on, which injects the sample into an optical detection region (ODR) at the baste of the flow cell 100.

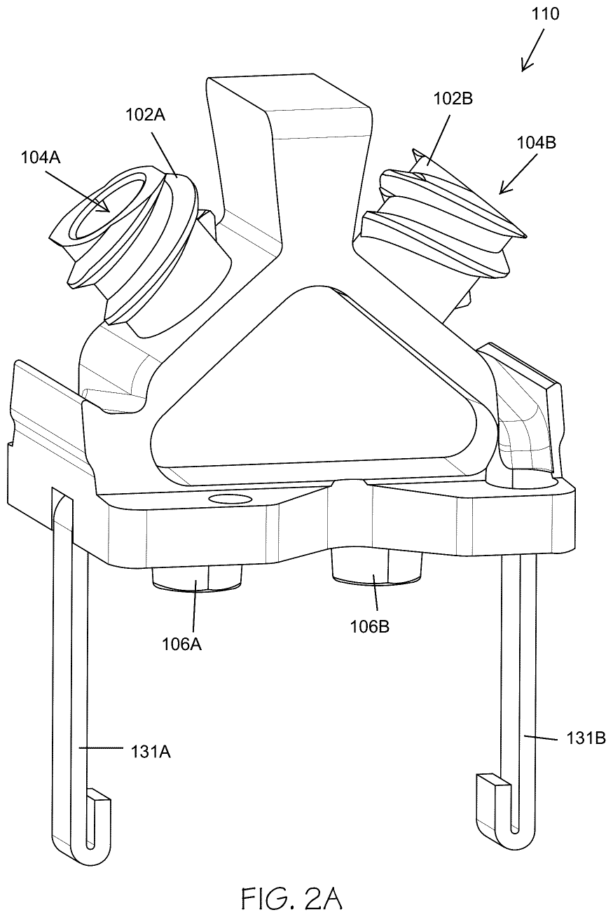

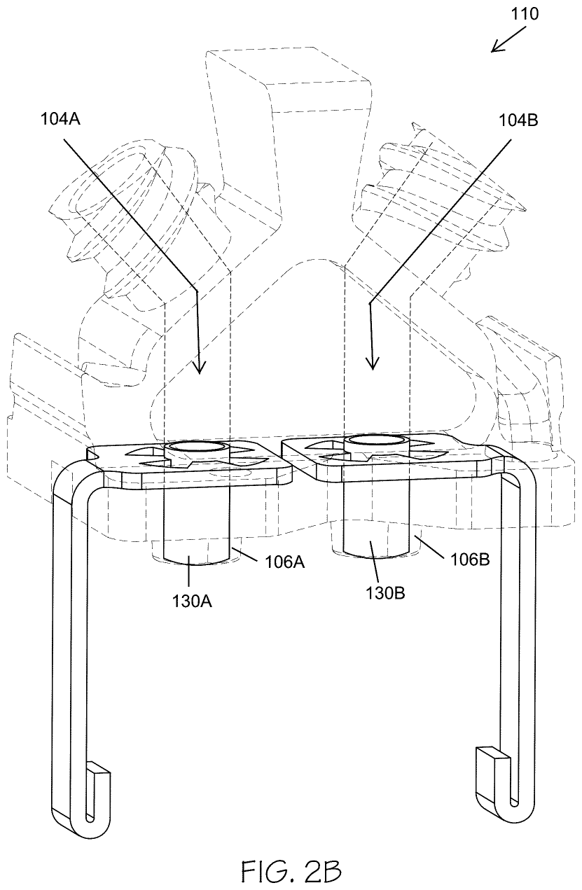

In some embodiments, the channels 104 include electrodes 130, for example, flow-through cylindrical, pipe, or leaf electrodes 130, for example, shown in FIG. 2B. The apparatus 100 can further include a pair of electrical connectors 131A, 131B (generally, 131) connected to the electrodes 130A, 130B, respectively, to connect to at least one external circuit (not shown). When inserted into the instrument, electrical connectors make a physical contact with the battery contact receptacles in the instrument. The top structure 110 may include a second set of luer fittings 106A, 106B (generally, 106) to attach to the channels 104A, 104B, respectively, and to external fluid connectors, for example syringe tips. Flow paths therefore extend between the first set of luer fittings 102 and the second set of luer fittings 106 through the channels 104. This configuration makes a leak free seal. When the both luers (106A and 106B) are pressed into receptacles (122A and 122B), a circular seal is formed on each luer due to the slight deformation the top luers. The fluid flow through a continuous curved cylindrical hole formed by the top and bottom structures can have a zero dead volume and is easily cleanable with floss, pipe cleaner, or an ultrasonic bath, or the like.

To ensure that the dual luers seal properly, the luers may be formed of a material such as polyethylene or polypropylene, or other soft material, but also can also include a hard inner core formed of a different material.

The apparatus 100 includes a bottom structure 120 including a set of luer fitting receptacles 122A, 122B (generally, 122) to connect to the second set of luer fittings 106A, 106B of the top structure 110, respectively.

The bottom structure 120 also includes one or more optical windows 124 to transmit in light to the ODR from a light source and to transmit out scattered light from a sample for detection and analysis. The bottom structure 120 also includes one or more indexing surfaces 128 to index on an external instrument electrophoretic mobility measurement instrument. Indexing surfaces helps in positioning the flow cell 100 within the external instrument with greater precision and repeatability. This is achieved by specifying the indexing surface dimensions at a tighter tolerance than other features. Mating surfaces in the external instrument will also be tightly toleranced to ensure the position of the ODR relative the sample cavity within the external instrument is precise and consistent between multiple installations of the flow cell 100 into the external instrument.

In an embodiment, the electrodes 130 include a metal selected from the group consisting of a noble metal and corrosion resistant stainless steel. For example, the noble metal could be platinum, palladium, gold flashed beryllium. In an embodiment, the electrical connectors 130 include press-fitting tabs to allow for the insertion of the electrodes 130 into the body of the top structure, more specifically, the second set of luer fittings 106 extending from the bottom surface of the top structure 110. The press-fitting tabs could allow for the insertion of the electrodes 130 with minimum amount of force while ensuring good mechanical and electrical contact between the electrodes 130 and the electrical connectors 131. The top portion 110 is reusable and therefore the amortized cost per test is low as compared to conventional flow cells.

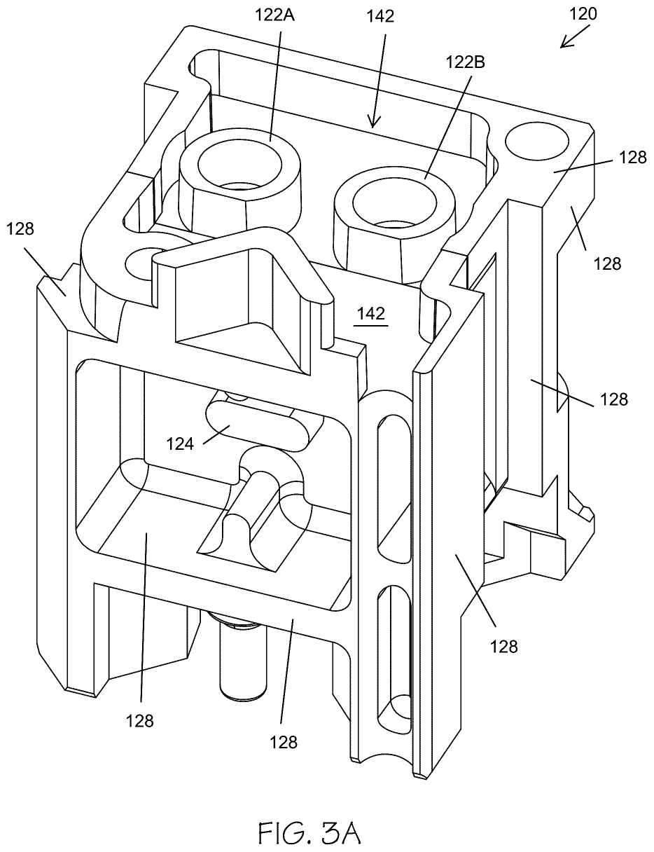

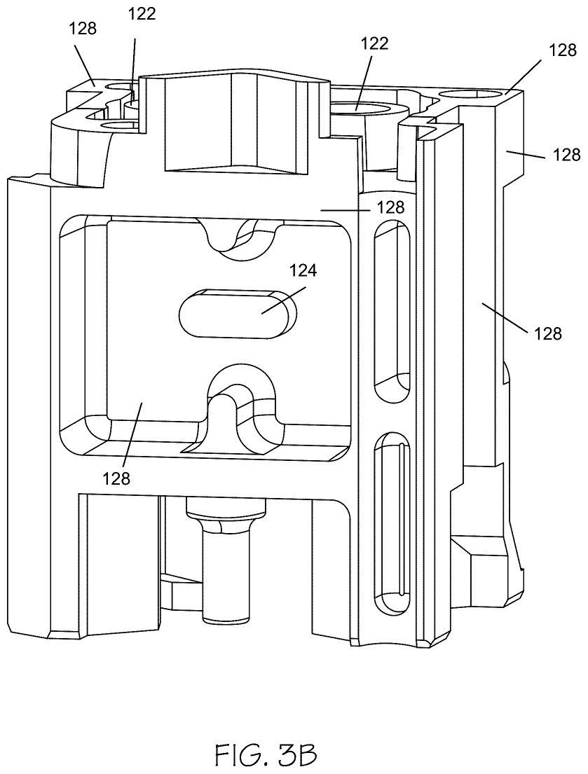

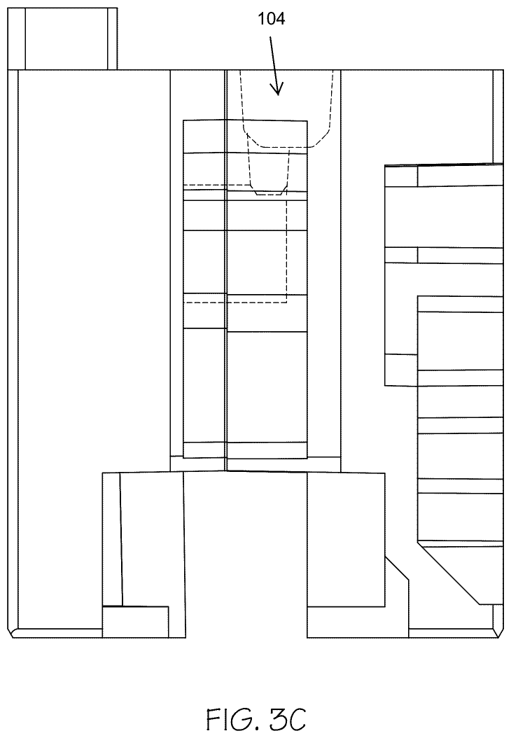

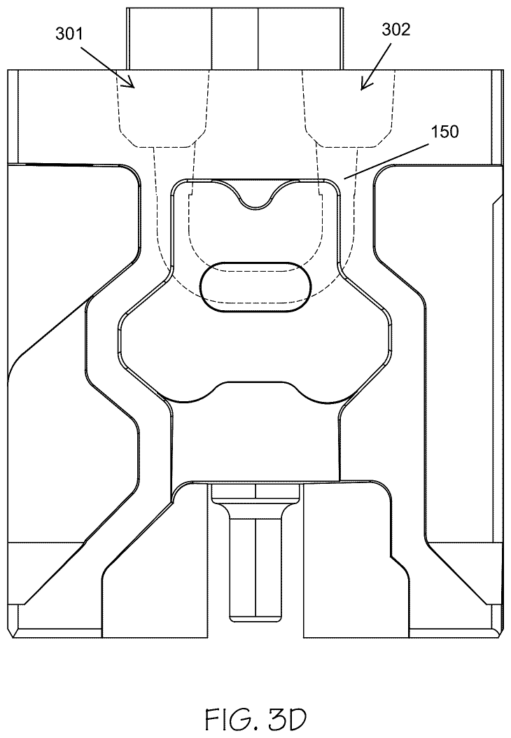

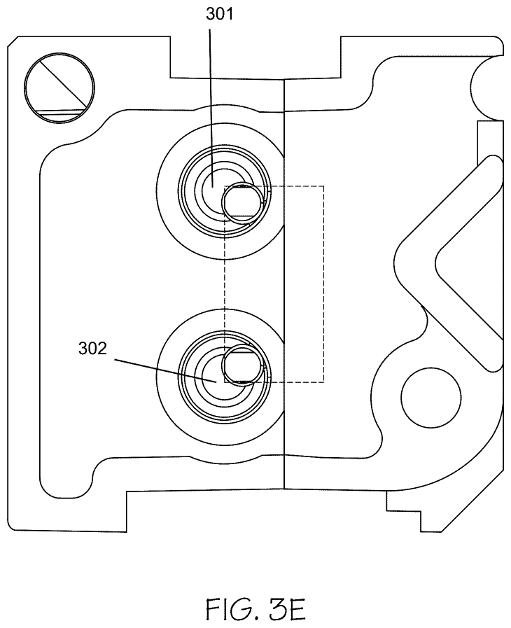

In an embodiment, as shown in FIG. 3A, the bottom structure 120 further includes at least one leak channel to divert leaked fluid to waste. In an embodiment, a total channel length of the flow cell 100 and a cross-sectional area of the flow cell 100 are chosen to minimize convection, joule heating, and sample volume. For example, the areas are chosen based on ergonomic design-fit in a read head of the instrument, such that if the areas are too small, then the flow cell 100 could not fit in the read head because the flow cell 100 would not be able to be manipulated with a user's fingers. In an embodiment, the ratio of the height of the flow cell 100 to the channel length of the flow cell 100 is about 1:5, as dictated by a u-shaped channel 150 (see FIG. 3D) in the bottom structure 120. In an embodiment, the optical windows 124 are recessed into the bottom structure 120 to prevent the windows 124 from being accidentally touched. Top Structure

In an exemplary embodiment, the flow cell 100 includes (1) a first set of luer fittings 102, (2) channels 104 coupled to the first set of luer fittings 102, where the channels 102 include flow-through cylindrical electrodes 130, (3) electrical connectors 131 connected to the electrodes 130 to connect to at least one external circuit, and (4) a second set of luer fittings 106 to attach to the channels 104 and to external fluid connectors. In an embodiment, the top structure 110 does not require optical molding. In an embodiment, the luer fittings 102, 106 are luer locks. In an embodiment, the flow-through cylindrical electrodes 130 allow fluid to flow through them, thereby avoiding the formation of bubbles in the fluid during use, e.g., when performing experiments. In an embodiment, the electrical connectors 131 are Be, Cu, or Au plated Cu—Be alloy. In an embodiment, the bottom structure 120 is a pure optical molding.

Referring again to FIG. 2A and FIG. 2B, in an embodiment, the electrodes 130 include a metal selected from the group consisting of a noble metal and corrosion resistant stainless steel that come in contact with solvent and generate an electrical field. For example, the noble metal could be platinum, palladium, gold flashed beryllium. In an embodiment, the electrical connectors 131 include press-fitting tabs to allow for the insertion of the electrodes into the top structure. The press-fitting tabs could allow for the insertion of the electrodes with minimum amount of force while ensuring good mechanical and electrical contact between the electrodes and the electrical connectors.

### Bottom Structure

In an exemplary embodiment, the bottom structure 120 of the flow cell 100 includes (1) a set of luer fitting receptacles 122 to connect to the second set of luer fittings 106 of the top structure 110 and form fluid paths with the first set of luer fittings 102A, 102B, respectively, (2) optical windows 124 to transmit in light from a light source and to transmit out scattered light from a sample for detection and analysis, and (3) indexing surfaces 128 to index on an external instrument electrophoretic mobility measurement instrument. The body of the bottom structure may be formed of injected molded plastic or other molded or machined material.

In an embodiment, FIG. 3A, FIG. 3B, FIG. 3C, and FIG. 3D depict the flow cell including (1) a set of luer fitting receptacles 122 to connect to the second set of luer fittings 106 to form fluid paths from/to the first set of luer fittings 102A, 102B, respectively, (2) optical windows 124 to transmit in light from a light source and to transmit out scattered light from a sample for detection and analysis, and (3) indexing surfaces 128 to index on an external instrument electrophoretic mobility measurement instrument. In an embodiment, the bottom structure 120 further includes at least one leak channel 142 to divert leaked fluid to waste.

In an embodiment, a total channel length of the flow cell and a cross-sectional area of the flow cell 100 are chosen to minimize convection, joule heating, and sample volume. For example, the areas are chosen based on ergonomic design-fit in a read head of the instrument, such that if the areas are too small, then the flow cell could not fit in the read head because the flow cell would not be able to be manipulated with a user's fingers. In an embodiment, the ratio of the height of the flow cell 100 to the channel length of the flow cell is about 1:5, as dictated by a u-shaped channel in the bottom structure. Although a u-shaped channel is shown, other shapes, configurations, or the like of the channel may equally apply that permit measurements to be performed at the ODR. In an embodiment, the optical windows 124 are recessed into the bottom structure to prevent the windows 124 from being mistakenly touched.

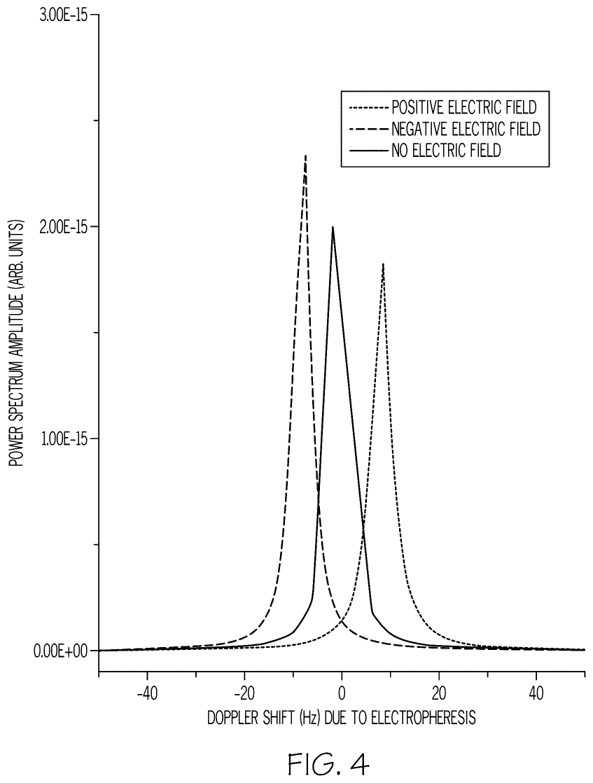

For example, FIG. 4 depicts the power spectrum output of an electrophoretic measurement instrument that uses the flow cell 100 of the present disclosure. The instrument, by using the flow cell 100, can distinguish between positive and negative Doppler shifts due to the application of positive and negative electric fields to the sample in the flow cell 100.

Accordingly, when assembled together as shown, the flow cell 100 delivers the following advantages. The flow cell 100 can be used for continuous tests with the same samples for days. Ease of use to easily remove bubbles before and during experiments. No risk of sample carry-over because the top half has no dead volume, while enables quick and reliable cleaning with solvent flush or nylon floss. Optimized channel dimensions that minimize sample convection and increases measurement accuracy. Data has been collected and validated. Easy handling features. Leak Management is integrated into the design. Optic protection to protect the optical surfaces from a user's fingerprints. Also, the flow cell can be assembled by hand, without tools.

In some embodiments, the flow cell 100 supports 100 psi sample pressure, needed for flow tests with an auto-titrator.

What is claimed is:

1. A flow cell comprising:
a top structure comprising:
a first set of luer fittings;
channels coupled to the first set of luer fittings,
wherein the channels comprise flow-through cylindrical electrodes, electrical connectors connected to the electrodes to connect to at least one external circuit; and
a second set of luer fitting to attach to the channels and to external fluid connectors; and
a bottom structure comprising:
a set of luer fitting receptacles to connect to the first set of luer fittings;
optical windows, and
indexing surfaces to index on an external electrophoretic mobility measurement instrument.

2. The flow cell of claim 1 wherein the electrodes comprise a metal selected from the group consisting of a noble metal.

3. The flow cell of claim 1 wherein the electrical connectors comprise press-fitting tabs to allow for the insertion of the electrodes into the top structure.

4. The flow cell of claim 1 wherein the bottom structure further comprises at least one leak channel to divert leaked fluid to waste.

5. The flow cell of claim 1 wherein a total channel length of the flow cell and a cross-sectional area of the flow cell are chosen to minimize convection, joule heating, and sample volume.

6. The flow cell of claim 1 wherein the optical windows are recessed into the bottom structure to prevent the windows from being mistakenly touched.

7. A flow cell comprising:
a first set of luer fittings;
channels coupled to the first set of luer fittings,
wherein the channels comprise flow-through cylindrical electrodes;
electrical connectors connected to the electrodes to connect to at least one external circuit; and
a second set of luer fitting to attach to the channels and to external fluid connectors.

8. The flow cell of claim 7 wherein the electrodes comprise a metal selected from the group consisting of a noble metal.

9. The flow cell of claim 7 wherein the electrical connectors comprise press-fitting tabs to allow for the insertion of the electrodes into the top structure.

10. A flow cell comprising:
a set of luer fitting receptacles to connect to a first set of luer fittings;
optical windows; and
indexing surfaces to index on an external electrophoretic mobility measurement instrument.

11. The flow cell of claim 10 wherein the flow cell comprises at least one leak channel to divert leaked fluid to waste.

12. The flow cell of claim 10 wherein a total channel length of the flow cell and a cross-sectional area of the flow cell are chosen to minimize convection, joule heating, and sample volume.

13. The flow cell of claim 10 wherein the optical windows are recessed into the bottom structure to prevent the windows from being mistakenly touched.
